(19) United States
(12) Patent Application Publication
(10) Pub. No.: US 2017/0148564 A1
(43) Pub. Date: May 25, 2017

(54) Automobile Ignition with Improved Coil Configuration

(71) Applicant: Intellitronix Corporation, Mentor, OH (US)

(72) Inventor: Paul Spivak, Mentor, OH (US)

(21) Appl. No.: 15/404,547

(22) Filed: Jan. 12, 2017

Related U.S. Application Data
(62) Division of application No. 14/056,745, filed on Oct. 17, 2013, now abandoned.

(51) Int. Cl. H01F 27/32; F02P 1/08; H01F 27/245; H01F 38/12; H01F 27/28

(52) U.S. Cl. CPC H01F 27/324; H01F 38/12; H01F 27/2823; H01F 27/2455; F02P 1/08

(57) ABSTRACT

An automobile ignition coil for use in an ignition system is provided having a central cylindrical magnetic core element, and a secondary coil circumscribing the core element. The second linear length of copper wire has a cross sectional area in a rectangular, rhomboid or hexagonal regular polygonal shape. A primary coil circumscribes the secondary coil, and similarly has a cross sectional area in a rectangular, rhomboid or hexagonal regular polygonal shape.

### RELATED APPLICATIONS

There present application is a divisional application of U.S. Ser. No. 14/056745.

### BACKGROUND OF THE INVENTION

1. Field of the Invention

The present invention relates to internal combustion engine ignition systems for generating a combustion spark for igniting the air-fuel mixture within the engine's cylinder and, more particularly, to an improved ignition system and ignition coil for generating and delivering a spark signal with greater efficiency.

2. Description of the Related Art

Ignition systems are well known in the field of internal combustion engines, and are used for igniting the fuel-air mixture within each cylinder. This creates combustion to drive the power stroke of the cycle. Prior generations of four-stroke engines used a mechanically timed electrical ignition system in which a distributor, containing a rotating cam (or rotor) driven by the engine's drive, directed the generated spark to each individual cylinder in a timely manner. An external ignition coil created high voltage, low current energy by converting it from a low voltage, high current battery. Wires direct the current from the coil to the distributor, and from the distributor to the spark plugs.

The power from the battery (which is charged by the car's electrical system using an alternator) is transformed by the coil for eventually transmission to the spark plugs. In these mechanically timed systems, the engine operates contact breaker points, which interrupt the current to an induction coil, in order to control the spark timing.

Various disadvantages exist in these mechanically timed ignition systems. These include, for example, the timing breaker points being subject to mechanical wear, as well as oxidation and burning at the contact surfaces from the constant sparking. Further, mechanical systems require regular adjustment to compensate for such wear, as well as to correct variation in the spark timing that can result from such mechanical variations over time. Such limitations result in obtaining only a reasonable service life of the system, and only if the power of the spark and ultimate engine speed are limited.

Current four-stroke engines utilize electronic ignition (EI) systems to solve such problems. In these systems, the control of the high primary current is accomplished through solid state switching, and contact breaker points are similarly replaced by an angular sensor of some kind, i.e., either optical, where a vaned rotor breaks a light beam, or more a Hall effect sensor, which responds to a rotating magnet mounted on the distributor shaft. The sensor output is shaped and processed by suitable circuitry within an “electronics box”, and then used to trigger a switching device such as a thyristor, which switches a large current through the coil.

In spite of improvements achieved by electronic ignition systems, they still utilize an otherwise conventional ignition coil (in series with a capacitor or condenser). This is, in essence, a type of electrical transformer in which low voltage, high amperage current is transformed to high voltage, low amperage current. The ignition coil consists of two transformer windings, the primary and secondary windings, sharing a common magnetic core. An alternating current in the primary induces alternating magnetic field in the coil's core. Because the ignition coil's secondary has far more windings than the primary, the coil is a step-up transformer which induces a much higher voltage across the secondary windings. For an ignition coil, one end of the windings of both the primary and secondary are connected together. This common point is connected to the battery (usually through a current-limiting ballast resistor). The other end of the primary is in electrical communication with the spark plugs, through a digital electronic ignition modules in EI systems, or through the distributor cap and rotor in mechanical systems.

Some more modern ignition designs are using an Engine Management Systems (EMS) to further control the spark timing and delivery, or an even more integrated Engine Control Unit (ECU) that controls both spark timing and delivery, as well as other engine functions, such as air/fuel mixture, idle speed, valve timing, torque, and the like. However, even these EMS and ECU arrangements retain a standard ignition coil of an otherwise conventional design. Some systems may dispense with a distributor altogether and have individual coils mounted directly atop each spark plug, which eliminates the need for both a distributor and high-tension leads. However, in these systems, multiple ignition coils are then deployed.

In all these systems, the ignition systems produces and delivers a high-voltage spark from the ignition coil, which was transformed from a low voltage battery supply source. The amount of energy in the spark required to ignite the air-fuel mixture varies depending on the pressure and composition of the mixture, and on the speed of the engine. Under laboratory conditions as little as 1 millijoule is required in each spark, but practical coils must deliver much more energy than this to allow for higher pressure, rich or lean mixtures, losses in ignition wiring, and plug fouling and leakage. When gas velocity is high in the spark gap, the arc between the terminals is blown away from the terminals, making the arc longer and requiring more energy in each spark. Between 30 and 70 millijoules are delivered in each spark.

The extremely high voltage causes a spark to form across the gap of the spark plug is delivered from the coil's secondary (typically 20,000 to 50,000 volts). This, in turn, ignites the compressed air-fuel mixture within the engine. It is the creation of this spark which consumes the energy that was stored in the ignition coil's magnetic field. In high performance engines with eight or more cylinders or in engines that operate at high r.p.m., both a higher rate of spark and a higher spark energy are required. Further, any efficiencies or losses created within th coil windings themselves can also tax or limit the coil's secondary output.

Consequently, improved efficiencies in the design and resulting operation of the ignition coil(s) can result in either improved ignition energy creation performance, or improved efficiency in the conversion of batter energy.

An otherwise conventional ignition coil consists of a laminated iron core surrounded by two coils of copper wire. Unlike a power transformer, an ignition coil has an open magnetic circuit where the iron core does not form a closed loop around the windings. The energy that is stored in the magnetic field of the core is the energy that is transferred to the spark plug.

The primary winding has relatively few turns of heavy wire. The secondary winding consists of thousands of turns of smaller wire, insulated for the high voltage by enamel on the wires and layers of oiled paper insulation. When demanded, current does not flow instantly because of the inductance of the coil. Because conventional wire windings have a generally round cross sectional area, the efficiency of packing these windings is limited, i.e. the given coil wire winding density is limited by the geometry and spacing of the packed windings. Since the inductance of the primary and secondary the inductance of the coil is limited by the coil winding density, an increasingly dense primary or secondary winding configuration can cause any induced current to flow longer and store more energy in the core magnetic field for the eventually delivered spark.

Consequently, a need exists for and a benefit can be obtained by providing an improved ignition system ignition coil for generating and delivering a spark signal with greater efficiency.

### SUMMARY OF THE INVENTION

It is therefore an object of the present invention to provide an improved automobile ignition system for an internal combustion engine.

It is a feature of the present invention to provide an improved ignition system and ignition coil for generating and delivering a spark signal with greater efficiency.

Briefly described according to the preferred embodiment of the present invention, an improved automobile ignition system is providing having an improved ignition coil configuration for generating and delivering a spark signal with greater efficiency. The improved ignition coil is formed around a magnetic core for formation of a magnetic field which is subsequently amplified as soon as voltage is applied. The core may be a solid iron core, or of a laminated configuration in which several thin ferromagnetic sheets are wound up to form a central cylindrical element. Circumscribing the core is a secondary coil, and circumscribing the secondary coil is a primary coil. The primary coil is formed of a linear length of a copper wire having a generally rectangular cross sectional area. The wire forming the primary coil is thicker and has a generally larger cross sectional area in comparison with that of the secondary coil. The secondary coil is similarly formed of a linear length of a copper wire having a generally rectangular cross sectional area. The wire forming the secondary coil is thinner and has a generally smaller cross sectional area in comparison with that of the primary coil. The primary coil itself further has a shorter overall length than the secondary coil. Consequently, the primary coil has significantly fewer windings that the secondary coil. In order to prevent electric discharge and spark-overs in the interior of the coil or outward, the windings of the primary and secondary coils must be insulated.

In otherwise conventional ignition coils, a high-quality winding of the coil wires is attempted in which the wires are precisely arranged and densely arranged, above one another, so that there is a minimized spacing between them. In the present invention, given the generally rectangular cross sectional area of the coil windings (both primary and secondary), the intra-wire spacing can be further reduces.

Finally, the cylindrical coil wound core is contained within a plastic or metallic housing that is filled with a with an oil, asphalt or an epoxy potting resin to prevent moisture intrusion, eliminate air bubbles and provide inslulatin of the created thermal load.

It is an overall objective of the present inventive ignition coil to provide an automobile ignition system with the generation of a greater spark signal, or for delivering a spark signal with greater battery efficiency.

It is thus an object of the present invention to provide a high frequency coil and/or high current capacity coil.

It is a further object of the present invention to provide the delivery of a spark that has enough voltage and energy to ensure combustion of the fuel mixture.

It is yet a further object of the present invention to be able to reliably accomplish these goals throughout a variety of rpm, load, temperatures and conditions.

Further features of the invention will become apparent in the course of the following description.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1a is a schematic diagram of an overall automobile ignition system 10 according to the PRIOR ART;

FIG. 1b, a similar automobile ignition system according to the PRIOR ART shown exemplifying an electronic ignition (EI) system;

FIG. 2 is a partial cutaway perspective view of an ignition coil of an otherwise conventional design according to the PRIOR ART for use with the automobile ignition system 10 of FIG. 1a;

FIG. 3 is a cross sectional elevational view of an of an ignition coil of an otherwise conventional design according to the PRIOR ART;

FIG. 4 is a cross sectional elevational view of an improved coil configuration in a block coil design according to the preferred embodiment of the present invention for use with an automobile ignition system;

FIG. 5a is a detailed cross sectional view taken along line V-V of FIG. 3 according to the PRIOR ART according to a first configuration;

FIG. 5b is a detailed cross sectional view taken along line V-V of FIG. 3 according to the PRIOR ART according to a second configuration;

FIG. 6 is a detailed cross sectional view taken along line VI-VI of FIG. 4;

FIG. 7a is an exemplary cross sectional conductor configuration according to a first alternate embodiment of the teachings of the present invention;

FIG. 7b is an exemplary cross sectional conductor configuration according to a second alternate embodiment of the teachings of the present invention;

FIG. 8 is an electrical schematic of an exemplary direct ignition system for an eight cylinder engine utilizing direct ignition coils in a pencil design according to the first alternate embodiment of the present invention;

FIG. 9 is a cross sectional elevational view of an improved coil on plug configuration in a pencil coil design according to a first alternate embodiment of the present invention for use with the exemplary direct ignition system of FIG. 7.

### DESCRIPTION OF THE PREFERRED EMBODIMENTS

The best mode for carrying out the invention is presented in terms of its preferred embodiment, herein depicted within the Figures wherein like reference numerals indicate the same parts throughout the several views.

### 1. Detailed Description of the Figures

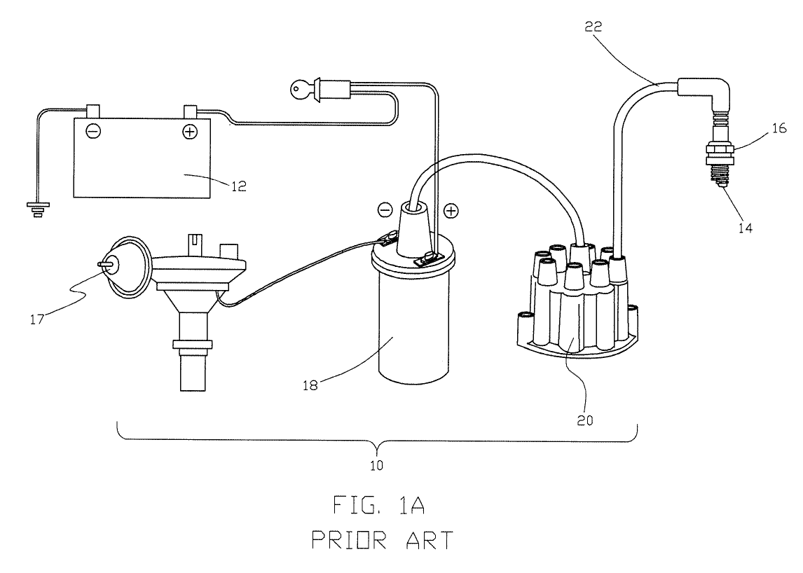

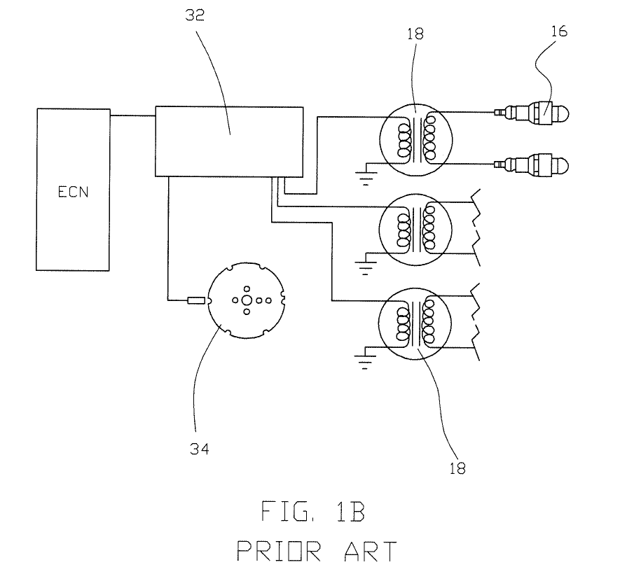

Referring now to FIG. 1a through FIG. 3, an overall automobile ignition system is generally noted as 10 according to the PRIOR ART. A typical 12-volt automotive ignition system 10 of a mechanically timed design is shown in FIG. 1a, and operates by taking in a low voltage with high current from the car's battery 12 and changing it into a higher voltage with lower current to jump the spark plug gap 14 of the spark plug 16 to propagate combustion in the cylinder (not shown). This process is initiated by a trigger module 17, and results in the changing of low voltage current of the battery to a high voltage. This induction process takes place in the coil 18. From there, the high voltage spark is transferred to the distributor 20 and on to a spark plug wire 22 which must deliver the spark to the cylinder that is coming up on the compression stroke.

As shown in FIG. 1b, a similar automobile ignition system according to the PRIOR ART is generally noted as 30 is shown exemplifying an electronic ignition (EI) system. In such a configuration the distributor 20 which provides mechanical timing and current distribution is replace with an ignition module 32, which controls the high primary current through solid state switching, and a triggering device 34, such as an optical or magnetic detection sensors, which responds in relation to the speed of the motor or, more specifically, to the speed of a distributor shaft. The ignition module processes the necessary signals and triggers delivery of a large current through the coil 18 to the spark plug 16. Additionally, an Engine Control Module (ECU) may be in further communication for adjusting and initiating the ignition cycle based upon other sensors and system parameters.

It should be apparent to a person having ordinary skill in the relevant art, in light of the teachings anticipated by the present invention, that an improved coil configuration according to the present invention may be applicable in conjunction with any of the presently available variations of automobile ignition systems currently available, whether mechanically timed or electronically timed, utilizing block coil designs or coil on plug designs, or others.

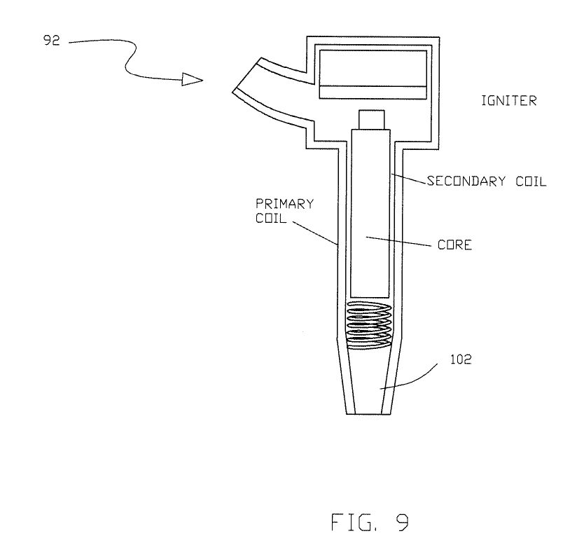

With an arrangement that includes a distributor 20 and block coils 18, the ignition voltage travels over the ignition cables 22 to the spark plugs 16. In an alternate design (for example, see FIG. 9 below), pencil coils sit directly on the spark plugs and an ignition cable is then only required when the ignition coil generates ignition energy for a second spark plug.

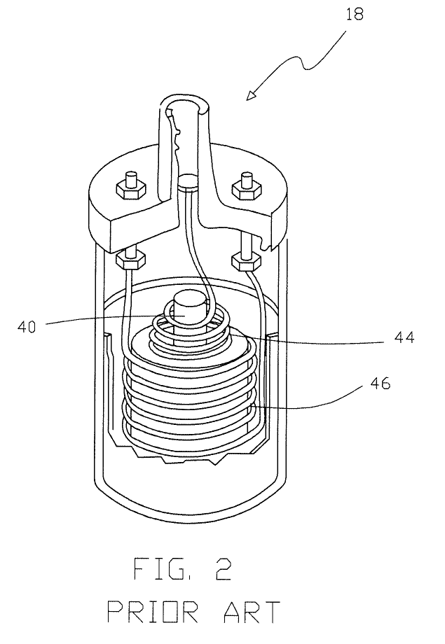

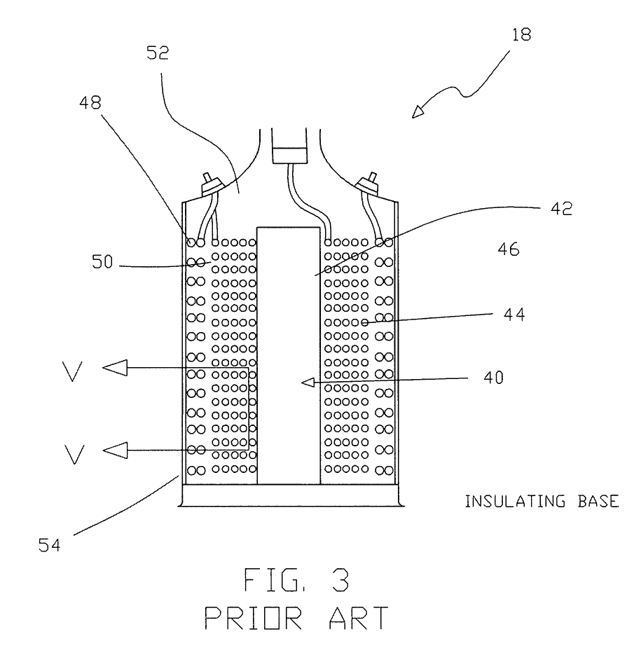

Referring in conjunction with FIG. 2-3, the block coil 18 of a conventional design of the PRIOR ART is shown in greater detail. In an otherwise conventional block coil 18, the ignition coil is formed around a magnetic core 40. The core 40 may be a solid iron core, or more preferably of a laminated configuration in which several thin ferromagnetic sheets 42 are wound up to form the central cylindrical element 40. Circumscribing the core 40 is a secondary coil 44, and circumscribing the secondary coil 44 is a primary coil 46. The primary coil 46 is formed of a linear length of a copper wire 48 having a generally circular cross sectional area. The secondary coil 44 is formed of a linear length of a copper wire 50 having a generally circular cross sectional area. The wire 48 forming the primary coil 46 is thicker and has a generally larger cross sectional area in comparison with that of the wire 50 forming the secondary coil 44.

The primary coil 46 is further of a shorter overall length than the secondary coil. 44 Consequently, the primary coil 46 has significantly fewer windings that the secondary coil 44. In order to prevent electric discharge and spark-overs in the interior of the coil or outward, the windings of the primary coils 46 and secondary coils 44 are insulated 52. Finally, a housing 54 contains the entire assembly to form a moisture resistant, insulated assembly.

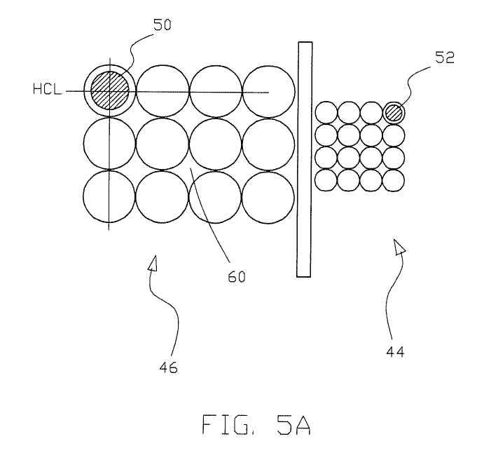

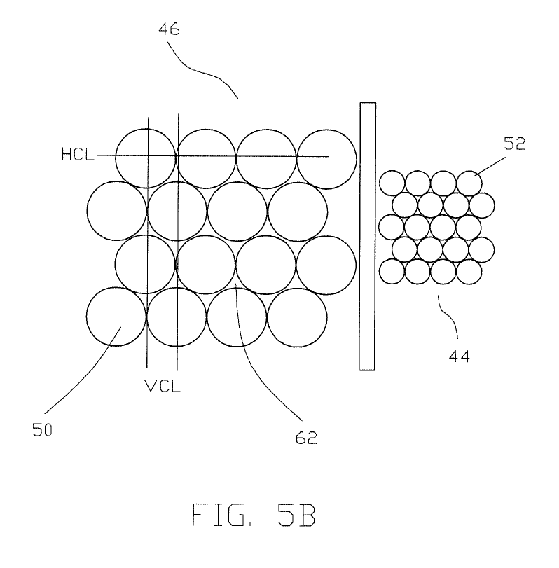

In otherwise conventional ignition coils, a high-quality winding of the coil wires is attempted in which the wires are precisely positioned and densely arranged, above one another, so that there is a minimized spacing between them. Referring now in conjunction with FIG. 5a and FIG. 5b, the generally configuration of the windings 44, 46 are shown. According to FIG. 5a, a first arrangement is depicted in which the primary wires 50 and secondary wires 52 of the respective windings are packed tightly in a regular array in which each wire 50, 52 is packed such as to align the vertical centerline VCL and horizontal centerline HCL of adjacent windings. Such a winding configuration is intended to increase winding density and decrease intra winding spacing 60. According to FIG. 5b, a second arrangement is depicted in which the primary wires 50 and secondary wires 52 of the respective windings are packed tightly in an alternating array in which each wire 50, 52 is packed such as to alternate the vertical centerline VCL and horizontal centerline HCL of adjacent windings. Such a winding configuration is intended to further increase winding density and further decrease intra winding spacing 62, depending upon the dimensions of the wire 50, 52, and the effectiveness and efficiency of the machinery utilized to accomplish the windings.

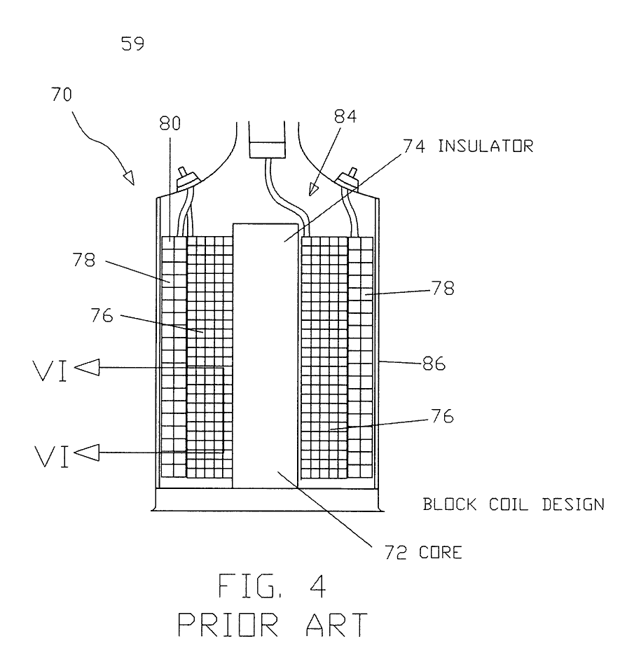

Referring now to FIG. 4, a cross sectional elevational view is shown of an improved coil configuration, generally noted as 70, in a block coil design according to the preferred embodiment of the present invention for use with an automobile ignition system. As will be shown, in the present invention, a generally rectangular cross sectional area of the coil windings (both primary and secondary), the intra-wire spacing can be further reduced.

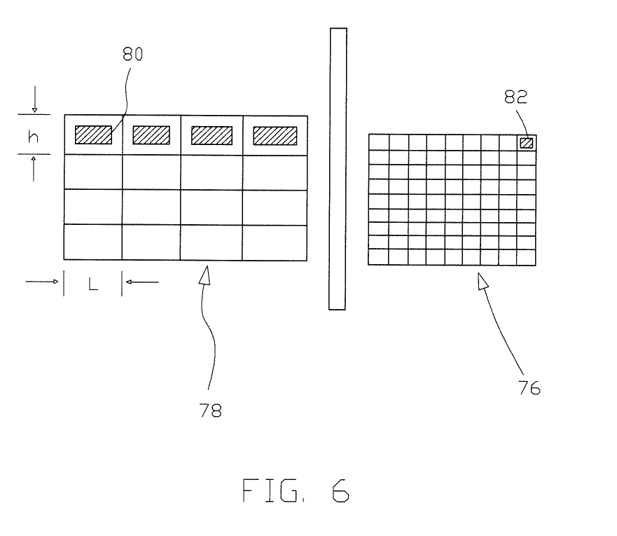

The improved coil 70 is formed around a magnetic core 72. The core 72 is preferably formed of a laminated configuration in which several thin ferromagnetic sheets 74 are wound up to form the central cylindrical element 72. Circumscribing the core 72 is a secondary coil 76, and circumscribing the secondary coil 76 is a primary coil 78. As shown in greater detail in conjunction with FIG. 6, the primary coil 78 is formed of a linear length of a copper wire 80 having a generally rectangular cross sectional area. The secondary coil 76 is formed of a linear length of a copper wire 82 having a generally rectangular cross sectional area. The wire 80 forming the primary coil 78 is thicker and has a generally larger cross sectional area in comparison with that of the wire 82 forming the secondary coil 76.

The primary coil 78 is further of a shorter overall length than the secondary coil 76. Consequently, the primary coil 78 has significantly fewer windings that the secondary coil 76. In order to prevent electric discharge and spark-overs in the interior of the coil or outward, the windings of the primary coils 78 and secondary coils 72 are insulated with a could compound or epoxy resin 84. Finally, a housing 86, formed of a plastic, or preferably metallic material, contains the entire assembly to form a moisture resistant, insulated assembly.

The regular configuration of the windings 80, 82 of the present invention are provided arrange adjacent wires to be packed far tighter, and with less intra winding spaces, than is otherwise available in standard wiring having generally circular cross sectional areas. In such a coil arrangement, there are generally four factors that affect the resistance of the wire conductor. These are:
I. the cross sectional area of a conductor (in a round cross section, calculated from the radius as A=π·r²); in a rectangular cross section, calculated as A=h·w);
ii. the length of the conductor;
iii. the temperature in the conductor;
iv. the material constituting the conductor
   In a coil winding configuration of the present invention, the coil cross sectional area will have an increased overall conductor area, as compared with otherwise conventional coil winding configurations. Consequently, decreased resistance, decreased inductance, and increased overall release of stored, available energy can be accomplished.

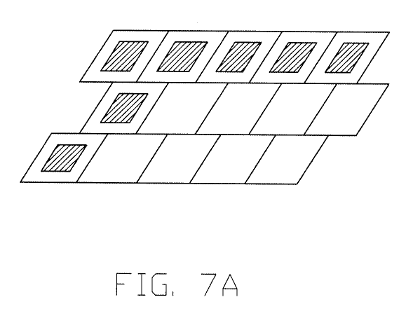

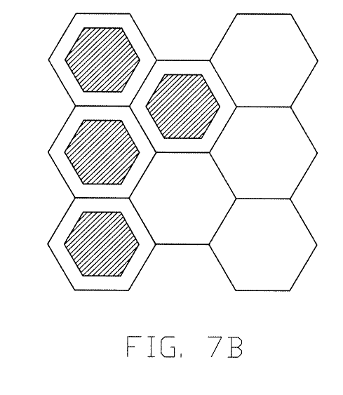

In light of the present teachings, is should now become apparent to those having sufficient skill in the relevant art, that the benefits and improvements of the present invention may be achieved utilizing coil winding wires having other polygonal shapes, other than circular, that further decrease the overall intra-wiring area in relation to the overall conductor cross sectional area. By way of example, and not as a limitation, FIG. 7a depicts a coil conductor arrangement utilizing conductors having a rhomboid shaped cross sectional area, and FIG. 7b depicts a coil conductor arrangement utilizing conductors having a hexagonal shaped cross sectional area.

### 2. Operation of the Preferred Embodiment

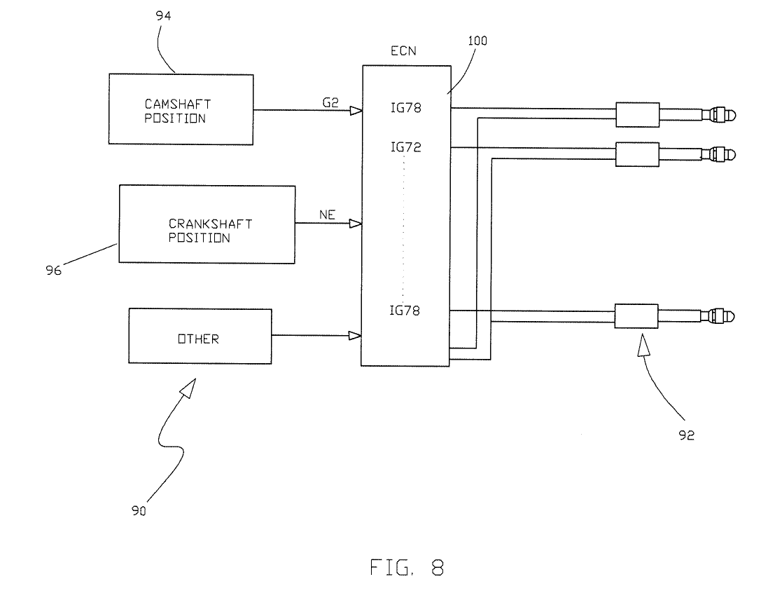

In operation, the present invention can provide an improved automobile ignition system for use with the improved coil configuration. As shown in FIG. 8 and FIG. 9, an electrical schematic of an exemplary Direct Ignition System (DIS), generally noted as 90, is shown for an eight cylinder engine utilizing direct ignition coils 92 in a pencil design according to the first alternate embodiment of the present invention. The DIS improves the ignition timing accuracy through the monitoring of cam positions sensor(s) 94, a crankshaft position sensor(s) 96, as well as various other sensors 98 within an electronic control module (ECM) 100. Further, reductions in high-voltage loses are created by the use of ignition coils 92 incorporating at least secondary, and preferably also primary coil configurations according to the present teachings. As show, the present DIS system is an independent ignition system which has one ignition coil 92 for each cylinder. The spark plug cap 102, which provide contact to the spark plugs (not shown) are integrated with the ignition coil. Additionally, an igniter 104 may be further integrated for simplification of disclosure. It should be apparent to a person having ordinary skill in the relevant art, in light of the teachings anticipated by the present invention, that an improved coil configuration according to the present invention may be applicable in conjunction with any of the presently available variations of automobile ignition systems currently available, whether mechanically timed or electronically timed, utilizing block coil designs or coil on plug designs, or others.

The foregoing descriptions of the specific embodiments are presented for purposes of illustration and description. They are not intended to be exhaustive nor to limit the invention to the precise forms disclosed and, obviously, many modifications and variations are possible in light of the above teaching. The embodiments are chosen and described in order to best explain principles of the invention and its practical application, and to thereby enable others skilled in the art to best utilize the invention and its various embodiments with various modifications as are suited to the particular use contemplated. It is intended that a scope of the invention be broadly defined by the Specification and Drawings appended hereto and to their equivalents; hence, the scope of the invention is to be limited only by the following claims.

What is claimed is:

1. An automobile ignition coil for use in an ignition system, said ignition coil comprising:
a magnetic core forming a central cylindrical element;
a secondary coil forming a second linear length of copper wire circumscribing said central cylindrical element;
a primary coil forming a first linear length of copper wire circumscribing said secondary coil, said first linear length being shorter that said second linear length;
said primary coil having fewer windings that the secondary coil;
insulation surrounding primary coils and said secondary coils; and
a housing containing said magnetic core, said primary coil, said secondary coil and said insulation and forming a moisture resistant, thermally insulated assembly;
wherein said secondary length of copper wire has a cross sectional area in a generally regular polygonal shape selected from the group consisting of:
rectangular; rhomboid; and hexagonal.

2. The ignition coil of claim 1, wherein said magnetic core is of a laminated configuration having multiple thin ferromagnetic sheets wound up to form the central cylindrical element.

3. The ignition coil of claim 1, wherein respectively adjacent windings of said secondary are packed tightly in a regular array in which each wire is packed such as to align the vertical centerline VCL and horizontal centerline HCL of adjacent windings.

4. The ignition coil of claim 3, wherein said housing is formed in a block coil design.

5. An automobile ignition coil for use in an ignition system, said ignition coil comprising:
a magnetic core forming a central cylindrical element;
a secondary coil forming a second linear length of copper wire circumscribing said central cylindrical element, said secondary copper wire having a cross sectional area in a generally regular first polygonal shape;
a primary coil forming a first linear length of copper wire circumscribing said secondary coil, said first linear length being shorter that said second linear length, said primary length of copper wire has a cross sectional area in a generally regular second polygonal shape, wherein said generally regular first polygonal shape and said regular second polygonal shape are each selected from the group consisting of: rectangular; rhomboid; and hexagonal;
said primary coil having fewer windings that the secondary coil;
insulation surrounding primary coils and said secondary coils; and
a housing containing said magnetic core, said primary coil, said secondary coil and said insulation and forming a moisture resistant, thermally insulated assembly.

6. The ignition coil of claim 5, wherein said first polygonal shape is different than said second polygonal shape.

7. The ignition coil of claim 5, wherein said magnetic core is of a laminated configuration having multiple thin ferromagnetic sheets wound up to form the central cylindrical element.

8. The ignition coil of claim 5, wherein respectively adjacent windings of said secondary are packed tightly in a regular array in which each wire is packed such as to align the vertical centerline VCL and horizontal centerline HCL of adjacent windings.

9. The ignition coil of claim 5, wherein respectively adjacent windings of said primary are packed tightly in a regular array in which each wire is packed such as to align the vertical centerline VCL and horizontal centerline HCL of adjacent windings.

10. The ignition coil of claim 7, wherein respectively adjacent windings of said secondary are packed tightly in a regular array in which each wire is packed such as to align the vertical centerline VCL and horizontal centerline HCL of adjacent windings.

11. The ignition coil of claim 10, wherein said housing is formed in a block coil design.

12. The ignition coil of claim 12, wherein said housing is formed in a pencil coil design.
